(19) United States
(12) Patent Application Publication
(10) Pub. No.: US 2024/0416710 A1
(43) Pub. Date: Dec. 19, 2024

(54) VEHICLE REAR AXLE

(71) Applicant: JAGUAR LAND ROVER LIMITED, Warwickshire (GB)

(72) Inventors: Edd Hugo, Whitley, Coventry, Warwickshire (GB); Gurdashan Singh, Whitley, Coventry, Warwickshire (GB); Neil Milburn, Whitley, Coventry, Warwickshire (GB); Roly Whear, Whitley, Coventry, Warwickshire (GB)

(21) Appl. No.: 18/703,487

(22) PCT Filed: Oct. 6, 2022
(86) PCT No.: PCT/EP2022/077866

§ 371 Date: Apr. 22, 2024

(30) Foreign Application Priority Data
Oct. 22, 2021 (GB) 2115220.2

(51) Int. Cl. B60G 21/055; B62D 7/15; B62D 21/11

(52) U.S. Cl. CPC B60G 21/0558; B62D 7/1581; B62D 21/11; B60G 2200/44; B60G 2204/122

(57) ABSTRACT

A vehicle (10) comprising: a rear axle mounted axial drive steering gear (12) positioned forward of a rear wheel centre axis (16); and a rear axle mounted active roll control unit (14) positioned forward of the rear wheel centre axis (16).

### TECHNICAL FIELD

The present disclosure relates to a vehicle rear axle. Aspects of the invention relate to a vehicle.

### BACKGROUND

It is known to provide suspension systems for vehicles with rear axle mounted steering gear and rear axle mounted active roll control units.

It is an aim of the present invention to address one or more of the disadvantages associated with the prior art.

### SUMMARY OF THE INVENTION

Aspects and embodiments of the invention provide a vehicle as claimed in the appended claims.

According to an aspect of the present invention there is provided a vehicle comprising: a rear axle mounted axial drive steering gear positioned forward of a rear wheel centre axis; and a rear axle mounted active roll control unit positioned forward of the rear wheel centre axis.

An advantage of this aspect of the invention is that additional vehicle components can be more easily packaged at the rear of the wheel centre axis, including a differential in a vehicle having an internal combustion engine, or an electric drive unit in an electric vehicle such as a battery electric vehicle.

The axial drive steering gear may be positioned above the active roll control unit. The axial drive steering gear and the active roll control unit may overlap, at least partially, in a vertical plane which is orthogonal to the longitudinal axis of the vehicle. This provides an advantage of allowing further vehicle components to be packaged behind the wheel centre axis.

The axial drive steering gear may convert linear motion to torque about a kingpin axis. The axial drive steering gear may be positioned forward of the kingpin axis.

The vehicle may comprise a left side suspension unit and a right side suspension unit. The active roll control unit may be positioned between a vehicle centreline and one of the left side suspension unit or right side suspension unit, on a first side of the vehicle centreline, to which a first end of the active roll control unit is coupled.

A second end of the active roll control unit may be coupled to the other of the left side suspension unit or right side suspension unit on a second side of the vehicle centreline. A second end of the active roll control unit may be coupled to the other of the left side suspension unit or right side suspension unit on a second side of the vehicle centreline via a cranked bar. This provides an advantage of optimising the packaging of components that are longitudinally oriented in the vehicle and that pass through the rear axle area.

The cranked bar may provide space for one or more vehicle components to be located beneath the cranked bar, within a vertical extent of the vehicle rear axle arrangement defined by the axial drive steering gear and the active roll control unit.

The active roll control unit may be an electric active roll control unit.

The vehicle may comprise vehicle propulsion system component mounting means for mounting a vehicle propulsion system component. The vehicle propulsion system component mounting means may be configured to locate a rear pitch axis of the vehicle propulsion system component, forward of the rear wheel centre axis. This provides the advantage of optimising the pitch of any connected components to minimise its impact on the packaging of other vehicle components.

The vehicle may comprise a vehicle propulsion system component. The vehicle propulsion system component mounting means may comprise four independent vibration isolators. Two of the vibration isolators may be located at a front of the vehicle propulsion system component and two of the vibration isolators may be located at a rear of the vehicle propulsion system component.

The two vibration isolators at the front of the vehicle propulsion system component may be of higher stiffness than the two vibration isolators at the rear of the vehicle propulsion system component.

The two vibration isolators at the front of the vehicle propulsion system component may limit the movement of the front of the vehicle propulsion system component more than the two vibration isolators at the rear of the vehicle propulsion system component limit the movement of the rear of the vehicle propulsion system component. The front of the vehicle propulsion system component may be located between the axial drive steering gear and active roll control unit.

The vehicle propulsion system component may be a differential.

At least a portion of differential may extend between the axial drive steering gear and the active roll control unit such that each one of said at least a portion of the differential, at least a portion of the axial drive steering gear and at least a portion of the active roll unit overlap in a vertical plane orthogonal to a longitudinal axis of the vehicle.

The vehicle may comprise an internal combustion engine having a propeller shaft or drive shaft. The axial drive steering gear and the active roll control unit may be separated, at least in part, by a vertical distance sufficient for the drive shaft of the vehicle, which may be located along the vehicle centreline, to be located between axial drive steering gear and the active roll control unit.

The vehicle propulsion system component may be an electric drive unit. The electric drive unit may be an offset electric drive unit, for propulsion of the vehicle, positioned rearward of the rear wheel centre axis.

The vehicle may comprise a vehicle loadspace with a horizontal or substantially horizontal floor capable of receiving a third row of passenger seats. The third row of passenger seats may provide a passenger foot well positioned vertically above the rear axle mounted axial drive steering gear.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates a vehicle in accordance with an embodiment of the invention;

FIG. 2 illustrates a simplified side view of components of the rear axle arrangement of the vehicle according to an embodiment of the invention;

FIG. 3 illustrates a schematic perspective view of a rear axle arrangement of the vehicle according to an embodiment of the invention;

FIG. 4 illustrates a perspective view of part of a battery electric vehicle according to an embodiment of the invention;

FIG. 5 illustrates a perspective view of part of an internal combustion engine vehicle according to an embodiment of the invention; and

FIG. 6 illustrates a cutaway side view of the rear axle arrangement of the vehicle according to an embodiment of the invention.

### DETAILED DESCRIPTION

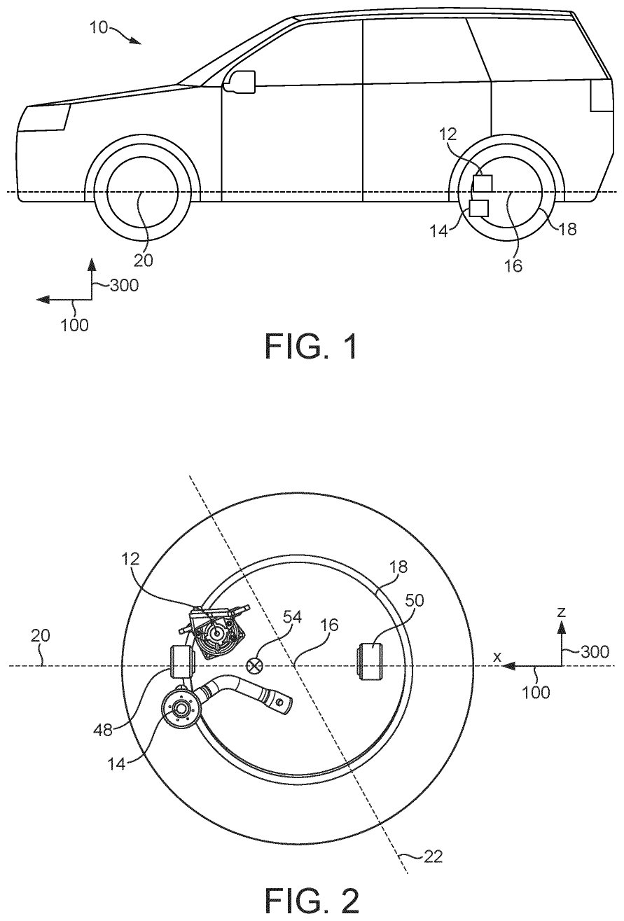

A vehicle in accordance with an embodiment of the present invention is described herein with reference to the accompanying FIGS. 1 to 6.

With reference to FIG. 1, there is shown a vehicle 10 according to an embodiment of the present invention, the vehicle comprising a steering system 12 and a roll control system 14. In particular, the vehicle comprises a steering system in the form of a rear axle mounted axial drive steering gear 12 positioned forward of a rear wheel centre axis 16, and a rear axle mounted active roll control unit 14 positioned forward of the rear wheel centre axis 16.

Such an arrangement provides more room for other vehicle components rear of the wheel centre axis 16 and flexibility for the suspension geometry at a wheel 18. FIG. 2 shows a simplified side view of the positioning of the axial drive steering gear 12 and active roll control unit 14 relative to the rear wheel centre axis 16 of the wheel 18.

As can be seen in FIG. 2, the axial drive steering gear 12 is positioned above the active roll control unit 14. In this arrangement ‘above’ means ‘higher than’, in a vertical (z) direction 300 relative to the horizontal plane 20 that is defined as the plane 20 passing through the wheel centres of each of the four wheels of the vehicle 10 when at rest, as seen in FIG. 1 and

FIG. 2. In this arrangement the term ‘above’ does not necessarily mean ‘directly above’. The axial drive steering gear 12 and active roll control unit 14 may not overlap when viewed from above. The axial drive steering gear 12 and active roll control unit 14 may not overlap when viewed from the side as in FIG. 2.

The axial drive steering gear 12 can be considered to be a high mounted axial drive steering gear 12, and the active roll control unit 14 can be considered to be a low mounted active roll control unit 14. The axial drive steering gear 12 is positioned above the rear wheel centre axis 16 in a vertical direction 300 and the active roll control unit 14 is positioned below the rear wheel centre axis 16 in the vertical direction 300.

The active roll control unit 14 in FIG. 2 is positioned forwards, in a horizontal direction 100, of the axial drive steering gear 12. In other embodiments, the active roll control unit 14 may be positioned directly below the axial drive steering gear 12, or rearwards, in a horizontal direction 100, of the axial drive steering gear 12.

The axial drive steering gear 12 may provide up to seven degrees of rear wheel steer. The axial drive steering gear 12 converts linear motion to torque about a kingpin axis 22, the axial drive steering gear 12 being positioned forward of the kingpin axis 22.

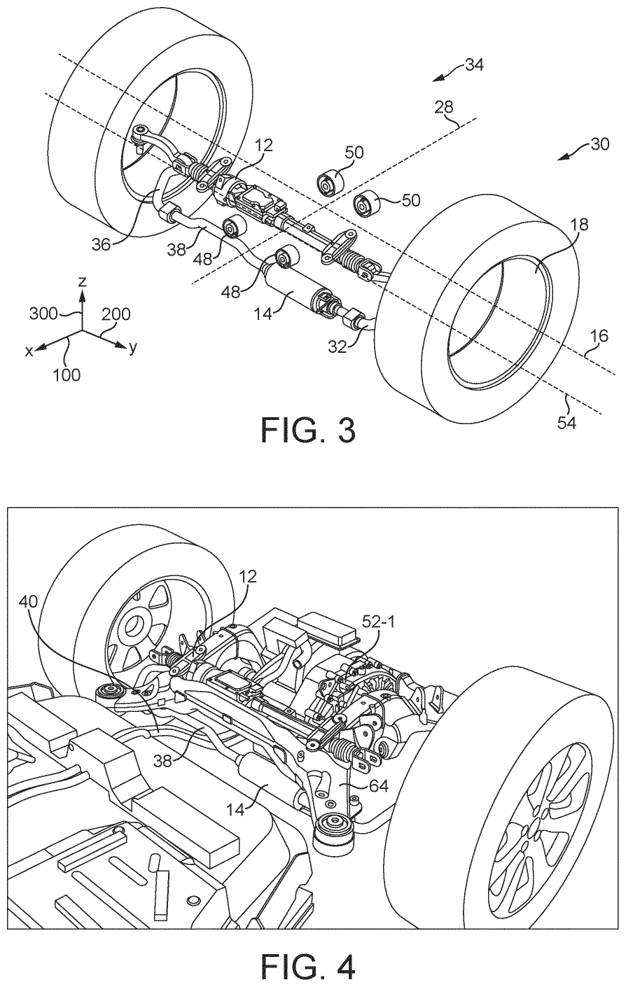

The axial drive steering gear 12, which may also be a concentric drive steering gear, is a steering gear that is compact in height and width, but is long in length in order to package the components of the steering gear required for operation. The axial drive steering gear 12 may for example comprise a screw drive mechanism to convert rotary motion of a steering gear motor, which is used to drive the steering gear, to linear motion of a steering bar, the steering bar being operatively coupled to the wheel for causing movement of the wheel, thereby providing steering of the wheel. The length of the axial drive steering gear 12 is positioned widthwise 200 in the vehicle 10, as illustrated in FIG. 3.

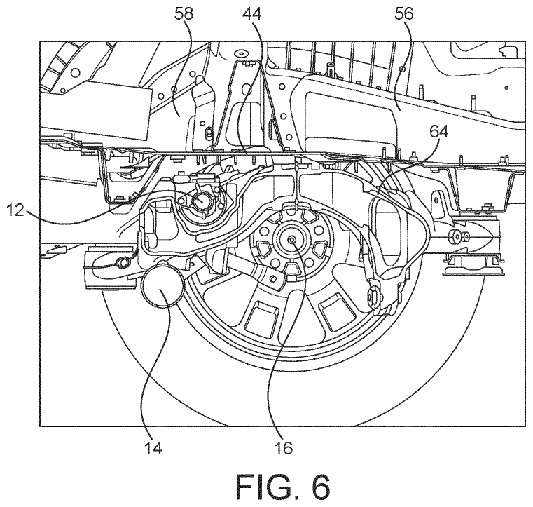

When the axial drive steering unit 12 is located above, even if directly above, the active roll control unit 14, the compact form of the axial drive steering gear 12 still allows for a low vehicle floor 44 of a vehicle rear loadspace 56, as shown in FIG. 6, which enables the vehicle 10 to have a flatter floor including the rear loadspace 56 or a seven seat vehicle arrangement.

The vehicle 10 may therefore comprise a vehicle rear loadspace 56 with a substantially horizontal floor 44 capable of receiving a third row of passenger seats, the third row of passenger seats providing a passenger foot well 58 positioned substantially vertically above the rear axle mounted axial drive steering gear 12.

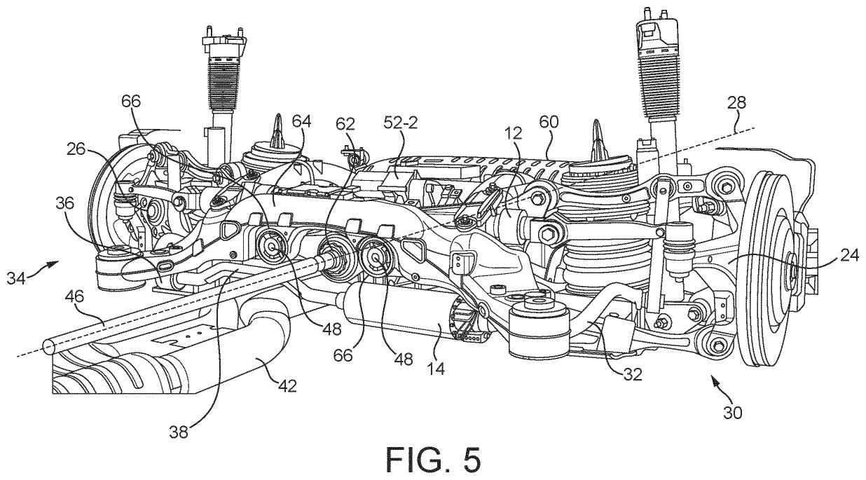

The vehicle 10 comprises a left side suspension unit 24, as shown in FIG. 5, and a right side suspension unit 26, as shown in FIG. 5, where left and right sides are defined looking at the vehicle 10 from the rear or from the position of a driver of the vehicle 10 looking forwards from the vehicle 10. The active roll control unit 14 may be positioned between a vehicle centreline 28 and the left side suspension unit 24 on a first side 30 of the vehicle centreline 28, to which a first end 32 of the active roll control unit 14 is coupled. A second end 36 of the active roll control unit 14 may be coupled to the right side suspension unit 26 on a second side 34 of the vehicle centreline 28, via a cranked bar 38.

The cranked bar 38 is a length of the supporting structure for the active roll control unit 14 which is bent or formed to provide a bridge over other vehicle components in a cranked section.

In some embodiments, where the vehicle 10 is a battery electric vehicle, the other vehicle components may include electrical cables 40, including high voltage electrical cables 40 of the vehicle 10 as shown in FIG. 4, which may be of large diameter and inflexible.

In some embodiments where the vehicle 10 comprises an internal combustion engine the other vehicle components may include an exhaust system 42 of the vehicle 10, as shown in FIG. 5. The exhaust system 42 of a vehicle 10 with an internal combustion engine can be offset routed, such that it passes underneath the cranked bar 38. The cranked bar 38 may provide space or passage for one or more vehicle components 40, 42 to be located beneath the cranked bar 38, within, or generally within a vertical extent of the vehicle rear axle arrangement defined by the axial drive steering gear 12 and the active roll control unit 14. That is, the cranked bar 38 bridges over the one or more vehicle components 40, 42.

In an alternative embodiment, the active roll control unit 14 may be positioned between a vehicle centreline 28 and the right side suspension unit 26, on the second side 34 of the vehicle centreline 28, to which the second end 36 of the active roll control unit 14 is coupled. The first end 32 of the active roll control unit 14 may then be coupled to the left side suspension unit 24 on the first side 30 of the vehicle centreline 28, via a cranked bar 38. This is in effect the mirror arrangement of the above described embodiment as shown in FIGS. 3 to 5.

The active roll control unit 14 may be a compact unit, that is, a unit which is less than half of the width of the vehicle rear axle between the left side suspension unit 24 and the right side suspension unit 26, in order to not be located at the vehicle centreline 28. This configuration allows a drive shaft 46 of a vehicle 10 with an internal combustion engine to be packaged without interfering with the operation of the active roll control unit 14.

The active roll control unit 14 may be an electric active roll control unit 14, and in particular may be a 12v electric active roll control unit or a 48V electric active roll control unit. The active roll control unit 14 may have a compact offset motor and/or gearbox unit, allowing it to be offset from the vehicle centreline allowing better packaging freedom. The active roll control unit 14 creates torque that needs to be converted to a linear force at the wheel 18 through the use of a linkage system comprising of a lever arm and a drop link. In alternative embodiments, the active roll control unit 14 may be a hydraulic active roll control unit, but may function in a similar way to the above described electric active roll control unit 14.

The vehicle 10 may have wheels 18 of a sufficiently large size, for example 20 inch wheels, in order to provide sufficient room, forward of the wheel centre axis 16, to package the axial drive steering gear unit 12 and active roll control unit 14.

The vehicle 10 may comprise a vehicle propulsion system component mounting means 48, 50 for mounting a vehicle propulsion system component 52. The vehicle propulsion system component mounting means 48, 50 are configured to locate a rear pitch axis 54 of the vehicle propulsion system component 52, forward of the rear wheel centre axis 16, as shown in FIG. 2 and FIG. 3.

The pitch axis 54 is defined relative to the vehicle 10. The pitch axis 54 is an axis across the vehicle width (y axis) 200, noting the roll axis is along the vehicle length (x axis) 100 and the yaw axis is vertically through the vehicle centre on a vertical axis (z axis) 300.

The vehicle 10 may comprise a vehicle propulsion system component 52, wherein the vehicle propulsion system component mounting means 48, 50 comprises four independent vibration isolators. Two of the vibration isolators 48 are located at a front of the vehicle propulsion system component 52 and two of the vibration isolators 50 are located at a rear of the vehicle propulsion system component 52.

The two vibration isolators 48 at the front of the vehicle propulsion system component 52 may be of higher stiffness than the two vibration isolators 50 at the rear of the vehicle propulsion system component 52. The two vibration isolators 48 at the front of the vehicle propulsion system component 52 may be smaller and/or harder than the two vibration isolators 50 at the rear of the vehicle propulsion system component 52. The vibration isolators 48, 50 may alternatively be known as bushes.

The effect of having the two vibration isolators 48 at the front of the vehicle propulsion system component 52 of higher stiffness, and/or being smaller and/or being harder, than the two vibration isolators 50 at the rear of the vehicle propulsion system component 52 is that the effective centre of rotation is moved or positioned, being the rear pitch axis 54, towards the front of the vehicle propulsion system component 52 such that movement at the front of the vehicle propulsion system component 52 is less than movement at the rear of the vehicle propulsion system component 52.

The two vibration isolators 48 at the front of the vehicle propulsion system component 52 limit the movement of the front of the vehicle propulsion system component 52 more than the two vibration isolators 50 at the rear of the vehicle propulsion system component 52 limit the movement of the rear of the vehicle propulsion system component 52, the front of the vehicle propulsion system component 52 in some embodiments being located between the axial drive steering gear 12 and active roll control unit 14 during normal operation of the vehicle 10.

The stiffness, size, and/or hardness, of the vibration isolators 48, 50 may be tuned to provide sufficient overall vibration absorption and/or vibration damping whilst minimising movement of the vehicle propulsion system component 52 at the front of the vehicle propulsion system component 52 to allow the packaging of the axial drive steering gear 12 close to the vehicle propulsion system component 52.

The vibration isolators 48, 50 may be natural rubber or another resilient material and have different hardness and/or geometry.

By tuning the stiffness, size, and/or hardness, of the front vibration isolators 48 and the rear vibration isolators 50, an overall rotation of the vehicle propulsion system component 52 can be provided which minimises movement at the front of the vehicle propulsion system component 52 whilst maintaining overall driver comfort.

In embodiments where the vehicle comprises an internal combustion engine with a drive shaft 46, by minimising the movement of the vehicle propulsion system component 52 at the front of the vehicle propulsion system component 52 by the increased stiffness, size, and/or hardness, of the two vibration isolators 48, 50 at the front of the vehicle propulsion system component 52, the vibration and/or movement of the drive shaft 46 is minimised allowing for tighter packaging of other components around the drive shaft 46.

In particular, the position and stiffness, size, and/or hardness, of the vibration isolators 48, 50 may help to minimise the amount that the drive shaft 46 moves up and down so minimises vertical packaging space required for drive shaft 46 in the area of the vehicle forward of the rear wheel centre axis 16.

In some embodiments the vehicle propulsion system component 52 is an electric drive unit 52-1, as shown in FIG. 4. The electric drive unit 52-1 is an offset electric drive unit, for propulsion of the vehicle 10, and may have a significant portion positioned rearward of the rear wheel centre axis 16. For example the rotor and stator assembly of the electric drive unit 52-1 may be positioned rearward of the rear when centre axis 16. Such an offset electric drive unit 52-1 has a motor out of line with a rear wheel drive shaft of the rear wheels with conventional gears coupling the motor with the rear wheel drive shaft.

In some embodiments the vehicle propulsion system component 52 is a differential 52-2, as shown in FIG. 5, such that the vehicle propulsion system component mounting means 48, 50 are differential mounting means or differential mounts for mounting a differential 52-2, wherein the differential mounting means 48, 50 are configured to locate or position a rear differential pitch axis 54 forward of the rear wheel centre axis 16.

The vehicle propulsion system component mounting means 48, 50 are mounted to a frame cross member 64 positioned above the active roll control unit 14. The frame cross member 64 provides mounting points 66 for the vehicle propulsion system component mounting means 48, 50.

In embodiments with an internal combustion engine and a drive shaft 46, the drive shaft 46 is on the vehicle centreline 28 between separate mounting points 66 with a clearance between the frame cross member and the vehicle centreline 28 which permits movement of the differential 52-2 and/or drive shaft 46 below the frame cross member 64 whilst preventing the differential 52-2 and/or drive shaft 46 from coming into contact with the frame cross member 64.

The front 62 of the differential 52-2, sometimes called the nose of the differential 52-2, is located towards the front of the vehicle 100, and can be configured to couple to the drive shaft 46. The rear of the differential 52-2 is located towards the rear of the vehicle 10. The front and rear of the vehicle 10 are defined by the front and rear of the vehicle 10 relative to normal forward movement of the vehicle 10. It is this front 62 of the differential 52-2 that may be positioned between separate mounting points 66.

The differential mounting means 48, 50 control the motion of the differential 52-2, the motion being imparted to the differential 52-2 when driveline torque is applied to the drive shaft 46.

In a vehicle 10 comprising a drive shaft 46, the axial drive steering gear 12 and the active roll control unit 14 are separated, at least in part, by a vertical distance sufficient to account for movement of the drive shaft 46 of the vehicle 10 when driveline torque is applied. The drive shaft 46 is then located between the axial drive steering gear 12 and the active roll control unit 14. The active roll control unit 14 is positioned below the drive shaft 46 of the vehicle 10 and the axial drive steering gear 12 is located above the drive shaft 46.

The separation of the axial drive steering gear 12 and the active roll control unit 14 does not need to be along the full extent of the axial drive steering gear 12 and the active roll control unit 14, as only a central part of those components needs to be separated enough for the drive shaft 46 to be located therethrough. Therefore the axial drive steering gear 12 and the active roll control unit 14 are separated along at least part of their lengths, where the length of each of these components is in the width direction of the vehicle, that is, perpendicular to the vehicle centreline 28 in a generally horizontal plane.

The above described packaging of the axial drive steering gear 12 and the active roll control unit 14 arrangement allows for a structural frame cross member 64 to be positioned within the vertical extent of the arrangement to provide body stiffness in an open back body style vehicle, such as a hatchback or sports utility vehicle (SUV), without affecting the low floor 44 of the vehicle 10, thereby allowing the positioning of a third row of seats with a foot well positioned, at least in part, over the axial drive steering gear 12 and the active roll control unit 14.

The arrangement of the axial drive steering gear 12 and the active roll control unit 14 along with a frame cross member 64 on the vehicle 10 may provide a space rearward of the rear wheel centre axis 16 for locating other vehicle components, such as an exhaust muffler 60 and/or a spare wheel.

The arrangement of the axial drive steering gear 12 and the active roll control unit 14 along with a frame cross member 64 on the vehicle 10 may provide a space rearward of the rear wheel centre axis 16 for locating other vehicle components, such as an offset electric drive unit.

It will be appreciated that various changes and modifications can be made to the present invention without departing from the scope of the present application.

1-15. (canceled)

16. A vehicle comprising:
a rear axle mounted axial drive steering gear positioned forward of a rear wheel center axis;
a rear axle mounted active roll control unit positioned forward of the rear wheel center axis;
vehicle propulsion system component mounting means for mounting a vehicle propulsion system component, wherein the vehicle propulsion system component mounting means are configured to locate a pitch axis of the vehicle propulsion system component, forward of the rear wheel center axis; and
a vehicle propulsion system component, wherein the vehicle propulsion system component is a differential,
wherein the axial drive steering gear and the active roll control unit are separated, at least in part, by a vertical distance sufficient for a front of the differential and/or a drive shaft connected to the differential, to be located between the axial drive steering gear and the active roll control unit.

17. A vehicle according to claim 16, wherein the vehicle propulsion system component mounting means comprises four independent vibration isolators, two vibration isolators located at a front of the vehicle propulsion system component and two vibration isolators located at a rear of the vehicle propulsion system component.

18. A vehicle according to claim 17, wherein the two vibration isolators at the front of the vehicle propulsion system component are of higher stiffness than the two vibration isolators at the rear of the vehicle propulsion system component.

19. A vehicle according to claim 18, wherein the two vibration isolators at the front of the vehicle propulsion system component limit the movement of the front of the vehicle propulsion system component more than the two vibration isolators at the rear of the vehicle propulsion system component limit the movement of the rear of the vehicle propulsion system component, the front of the vehicle propulsion system component being located between the axial drive steering gear and active roll control unit.

20. A vehicle according to claim 16, wherein at least a portion of differential extends between the axial drive steering gear and the active roll control unit such that each one of said at least a portion of the differential, at least a portion of the axial drive steering gear and at least a portion of the active roll unit overlap in a vertical plane orthogonal to a longitudinal axis of the vehicle.

21. A vehicle according to claim 16, wherein the axial drive steering gear is positioned above the active roll control unit.

22. A vehicle according to claim 16, wherein the axial drive steering gear converts linear motion to torque about a kingpin axis, the axial drive steering gear being positioned forward of the kingpin axis.

23. A vehicle according to claim 17, the vehicle comprising a left side suspension unit and a right side suspension unit, wherein the active roll control unit is positioned between a vehicle centerline and one of the left side suspension unit or right side suspension unit, on a first side of the vehicle centerline, to which a first end of the active roll control unit is coupled.

24. A vehicle according to claim 23, wherein a second end of the active roll control unit is coupled to the other of the left side suspension unit or right side suspension unit on a second side of the vehicle centerline, via a cranked bar.

25. A vehicle according to claim 24, wherein the cranked bar provides space for one or more vehicle components to be located beneath the cranked bar, within a vertical extent of the vehicle rear axle arrangement defined by the axial drive steering gear and the active roll control unit.

26. A vehicle according to claim 16, wherein the active roll control unit is an electric active roll control unit.

27. A vehicle according to claim 16, wherein the vehicle comprises an internal combustion engine having a drive shaft, which is located along the vehicle centerline.

28. A vehicle according to claim 16, wherein the vehicle comprises vehicle loadspace with a substantially horizontal floor capable of receiving a third row of passenger seats, the third row of passenger seats providing a passenger foot well positioned vertically above the rear axle mounted axial drive steering gear.
